(19) United States
(12) Patent Application Publication
(10) Pub. No.: US 2015/0057835 A1
(43) Pub. Date: Feb. 26, 2015

(54) DRIVER ASSISTANCE SYSTEM, MOTOR VEHICLE HAVING A DRIVER ASSISTANCE SYSTEM, AND A METHOD FOR OPERATING A DRIVER ASSISTANCE SYSTEM

(71) Applicant: GM GLOBAL TECHNOLOGY OPERATIONS LLC, Detroit, MI (US)

(72) Inventor: Thomas Streubel, Chemnitz (DE)

(21) Appl. No.: 14/465,623

(22) Filed: Aug. 21, 2014

(30) Foreign Application Priority Data
Aug. 21, 2013 (DE) 102013013747.0

(51) Int. Cl. B60W 30/095; B60W 30/09

(52) U.S. Cl. CPC B60W 30/095; B60W 30/09
USPC 701/1

(57) ABSTRACT

A driver assistance system and method for a motor vehicle includes a detector that is designed to detect at least one object in the area surrounding the vehicle. A vector field generator is configured to create an environmental potential field for the at least one object detected in the area surrounding the vehicle and to calculate a vector field from the created environmental potential field. A control device is configured to define control commands for the vehicle on the basis of the calculated vector field.

### CROSS REFERENCE TO RELATED APPLICATION

This application claims priority to German Patent Application No. 102013013747.0 filed Aug. 21, 2013, which is incorporated herein by reference in its entirety.

### TECHNICAL FIELD

The technical field relates to a driver assistance system, a motor vehicle having a driver assistance system, and a method for operating a driver assistance system.

### BACKGROUND

Driver assistance systems for motor vehicles are known. Such driver assistance systems (ADAS=Advanced Driver Assistance System) are electronic auxiliary devices that assist a vehicle driver in certain driving situations. ADAS are capable of intervening and thus actively influencing driving behaviour by braking, accelerating or making appropriate steering adjustments. The driver can also receive warnings before or during a critical situation via a suitable signalling arrangement. In response to such warnings, the driver may then himself actively adjust his driving behaviour.

For example, German Patent Application DE 10 2006 042 666 A1 discloses a method for avoiding or minimising the consequences of a collision between a vehicle and an object. In this context, the current status of the vehicle is determined with the aid of a vehicle sensor system, and objects in the detection range of the sensors are detected with the aid of an environmental sensor system, and an action to prevent or minimise the consequences of a collision is determined, taking into account the current status of the vehicle.

In order to be able to function properly, driver assistance systems have to be supplied with the most accurate information possible regarding the environment around the vehicle. This information must captured, processed and presented in real time. For this, data from one or more sensors can be received and analysed. Particularly when information from multiple sensors is to be analysed simultaneously, the capabilities and capacities of the driver assistance system are subjected to enormous loads. To address this, the processing systems must be very fast, powerful, and correspondingly expensive.

### SUMMARY

Given the situation described above, the object underlying one embodiment of the present disclosure is to provide a driver assistance system and a method for operating a driver assistance system that enables the information about the vehicle's surroundings to be processed efficiently.

This object is solved by the features of the independent claims.

The independent claims respectively provide for:
A driver assistance system for a vehicle, including a detector that is designed to detect at least one object in the area surrounding the vehicle; a vector field generator that is designed to create an environmental potential field for the at least one object detected in the area surrounding the vehicle, and to calculate a vector field from the created environmental potential field; and a control device that is designed to define control commands for the vehicle on the basis of the calculated vector field, which commands will guide the vehicle past the at least one detected object.
A method for operating a driver assistance system for a vehicle, comprising detecting at least one object in the area surrounding the vehicle; creating an environmental potential field for the at least one detected object; calculating a vector field from the created environmental potential field; and defining a control command for the vehicle that guides the vehicle past the at least one detected object using the calculated vector field.
A motor vehicle equipped with a driver assistance system.

The idea on which an embodiment is based includes modelling a potential field from the information about the area surrounding the vehicle in such a way that a greater potential is assigned to objects. Such an artificial potential field may be described in a similar manner to a gravitation field. The negative gradient of such an artificial potential field points away from a potential hazard and so forms a vector field which can be used directly for planning the travel of a vehicle, or as an input variable for an automated vehicle control system.

The vector field of the artificial potential field calculated in this way is interpreted as a force field. An host vehicle in this field is subject to the influence of its environment and is thus guided through the environment with the aid of the calculated artificial vector field. Such an approach significantly simplifies the planning of a path for the host vehicle.

The information about the objects in the area surrounding the vehicle may originate from several different sensors. When this information from different sensor sources is merged to form a common potential field, the different types of information from the sensors can be combined and analysed efficiently, and therefore quickly. Consequently, this arrangement lends itself well to real time processing, as is essential for driver assistance systems.

To this end, the system includes a detector that is designed to detect at least one object in the area surrounding the vehicle. Such a detector may comprise one or also more sensors, which monitor the area surrounding the vehicle and deliver information about objects detected in the area. Said sensors may be active sensors, ultrasonic or radar sensors for example, or passive sensors, such as a camera.

The driver assistance system is also equipped with a vector field generator, which creates an environmental potential field from the objects detected in the area surrounding the vehicle. This environmental potential field is an artificial potential field. The potential field is constructed similarly to a gravitational field. After the environmental potential field has been created by the vector field generator, a vector field is calculated from the environmental potential field. This vector field is derived from the negative gradient of the environmental potential field. This calculated vector field is interpreted as a force field, which has a direct influence on the movement of the host vehicle. Also, the gradients for the longitudinal and lateral directions can be calculated separately (superposition principle).

The driver assistance system is also equipped with a control device that is designed to define control commands for the vehicle using the previously calculated vector field, and which guide the vehicle past the at least one detected object. With the calculated vector field, said control device derives the direction in which the host vehicle is moving from the forces acting on the host vehicle. Since in this context a repellent force effect acts on the host vehicle from all objects previously detected in the area surrounding it, the host vehicle will use the resulting force to plot a path past all detected objects avoiding all collisions to the extent possible. In this process, the control device may also define control commands using the calculated vector field to speed the vehicle up or slow it down. In particular, if it is not possible to navigate around an object, the host vehicle may be slowed in this manner, even coming to a complete standstill when confronted with such an obstacle.

The present disclosure further provides a method that detects at least one object in the area surrounding the vehicle, creates an environmental potential field for the at least one detected object, calculates a vector field from the environmental potential field created, and defines a control command for the vehicle that guides the vehicle past the at least one detected object using the calculated vector field.

The present disclosure also provides a motor vehicle equipped with a driver assistance system according to the disclosure.

Finally, the present disclosure provides a software product with a computer program comprising instructions that cause a computer-controller device to carry out a method according to the disclosure.

The present disclosure enables information about the area surrounding a vehicle to be processed efficiently and economically in terms of resources. The present disclosure further enables the merging of sensor data from a multiplicity of sensors of the same or different kinds about objects in the area surrounding a vehicle. This enables a driver assistance system to be manufactured less expensively.

Advantageous variations and refinements will be apparent from the related dependent claims and from the description with reference to the drawing figures.

In one embodiment, the vector field generator creates a plurality of environmental potential fields, superimposes the created plurality of environmental potential fields over each other to produce a total potential field, and calculates the vector field from the total potential field. Separate processing of objects detected singly in the area surrounding the vehicle enables the corresponding potential fields to be created efficiently. This is particularly advantageous with detection results originating from different sensor sources. If the potential fields calculated are then superimposed on each other, the data collected can undergo further processing rapidly and economically in terms of resources.

In one embodiment, the detector comprises a plurality of sensors, which detect an object in the area surrounding the vehicle. The detection area can be expanded by using a plurality of sensors for object detection. In addition, the use of a plurality of sensors for object detection enables redundant monitoring of the area around the vehicle, and thus also improves reliability.

In another embodiment, the detector comprises at least one radar sensor, an ultrasonic sensor, a camera and/or a LIDAR. Such sensors are particularly suitable for detecting objects in the area surrounding a vehicle.

In another embodiment, the vector field generator is designed such that it is able to adapt the environmental potential field of a detected object as a function of a speed of the vehicle and a relative speed between the vehicle and the detected object. By adapting the potential field of detected moving objects in this way, the potential field may be constructed so that a proper safety distance is always maintained between the host vehicle and an object, and the incidence of the vehicle and objects coming closer to each other than this safety distance is minimised, even if said objects are moving.

In another embodiment, the driver assistance system also comprises a memory that is designed to store control guidelines for controlling the vehicle, wherein the vector field generator generates a control potential field using the stored control guidelines and superimposes the control potential field on the environmental potential field. Control guidelines for controlling the vehicle may be for example guidelines or rules based on the prevailing traffic regulations. For example, one such rule may be the instruction to drive on the right, that is to say, if more than one traffic lane is detected, the vehicle should preferably use the right lane. Equally, guidelines regarding recommended speeds, speed limits, distances to maintain when following another vehicle, etc., may also be stored as guidelines either statically or dynamically in the memory.

In another embodiment, the detector comprises a communication interface that is designed to receive information about an object in the area surrounding the vehicle. Such information is preferably transmitted to the communication interface of the detector wirelessly. Said transmission of information from the area surrounding the vehicle may be for example data from a car-to-car communication or a car-to-X communication. For example, information about possible hazards may be entered early in the driver assistance system and taken into account for the purpose of vehicle controlling. With such communication, static or even dynamic restrictions or regulations relating to the route currently being travelled may also be loaded into the driver assistance system. For example, an overtaking ban of short duration or length or similar may be taken into account.

In another embodiment, the control device defines control commands for a longitudinal and/or lateral control of the vehicle. With a longitudinal control of the vehicle, the speed of the vehicle may be modified. In this way, the vehicle may be either accelerated if the road is clear or decelerated if obstacles are present. If necessary the speed of the vehicle may also be adjusted to match the speed of vehicles ahead. A lateral control of the vehicle is responsible for steering movements. Thus, it is possible to keep the vehicle accurately in the required travel lane. If obstructions are encountered in the path the vehicle is following, an early avoidance manoeuvre may be executed by the driver assistance system with a lateral control, thereby preventing a potential collision. Moreover, overtaking manoeuvres or similar are also possible with appropriate steering movements. In order to avoid overcompensation, possibly leading to swerving or slewing with lateral control of the vehicle, if necessary a suppression function may be integrated in the control circuit for lateral control.

In another embodiment, the vector field generator creates the environmental potential field on the basis of a predefined model. This model may specify fixed potential values for known, predetermined object classes. For example, potential models or calculation rules may be specified for lane markings, or for vehicles that are ahead of the host vehicle or travelling in the opposite direction. This enables the potential fields for the detected objects to be determined quickly and reliably.

The present disclosure further comprises a device for operating a driver assistance system for a vehicle that is equipped with a device for detecting at least one object in the area surrounding the vehicle, a device for creating an environmental potential field for the at least one detected object, a device for calculating a vector field from the created environmental potential field, and a device for defining a control command for the vehicle that guides the vehicle past the at least one detected object using the calculated vector field.

In one embodiment, the device for operating a driver assistance system for a vehicle also includes a device for superimposing of plurality of environmental potential fields over each other to produce a total potential field, wherein the device calculates the vector field by deriving the vector field from the total potential field.

In another embodiment, the device for operating the driver assistance system comprises a device for providing control guidelines for controlling the vehicle, a device for creating a control potential field using the stored control guidelines, and a device for superimposing the control potential field on the environmental potential field.

In another embodiment, the device for defining the control command defines a control command for a longitudinal and/or lateral control of the vehicle.

The above variations and refinements may be implemented together in any meaningful combination. Other possible variations, refinements and implementations of the disclosure also include combinations of features that have not been or will not be described explicitly in the following explanation of the embodiments. In particular, a person skilled in the art will also be able to add individual aspects to the respective basic structure of the present disclosure in the form of improvements or additions.

### BRIEF DESCRIPTION OF THE DRAWINGS

The present disclosure will hereinafter be described in conjunction with the following drawing figures, wherein like numerals denote like elements, and:

FIG. 1 is a schematic representation of a block diagram of an embodiment of a driver assistance system;

FIG. 2 is a schematic representation of a vehicle equipped with an embodiment of a driver assistance system;

FIG. 3 is a representation of a cross section through a potential field of a two-lane road;

FIG. 4 is a schematic representation of a cross section through a potential field of a moving obstruction;

FIG. 5 is a schematic representation of an overtaking manoeuvre of a vehicle equipped with an embodiment of a driver assistance system; and

FIG. 6 is a schematic representation of a flowchart for an embodiment of a method.

The accompanying figures of the drawing are intended to provide a clearer understanding of the embodiments of the disclosure. They illustrate embodiments and, in conjunction with the description, help to explain principles and concepts of the disclosure. Other embodiments, and many of the advantages cited will be apparent upon review of the drawings. The elements of the drawings are not necessarily drawn to a common scale.

Unless otherwise stated, elements, features and components in the drawing figures that are identical or have an identical function or effect are identified with the same reference sign.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

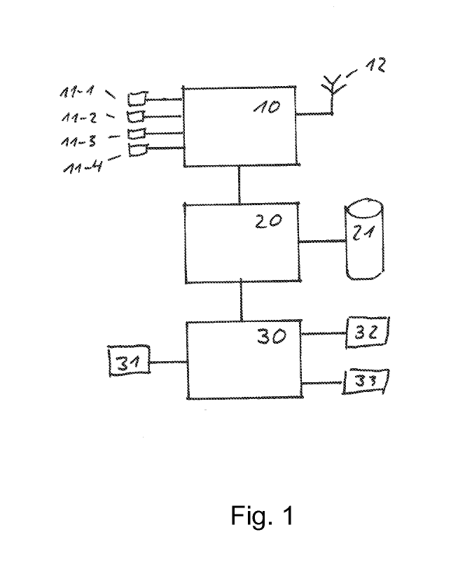

The driver assistance system 1 in FIG. 1 comprises a detector 10, a vector field generator 20 and a control device 30. Detector 10 comprises sensors 11-1 to 11-4. Each of these sensors 11-1 to 11-4 monitors at least a part of the area surrounding a vehicle. Sensors 11-1 to 11-4 may for example be ultrasonic sensors, radar sensors, a camera or a LIDAR. Any other kind of sensor that makes it possible to capture the area surrounding a vehicle actively or passively and in so doing detect objects in the surrounding area is also conceivable.

Detector 10 may also comprise a communication interface 12. With such a communication interface 12, detector 10 is also able to receive additional information about objects in the area surrounding the vehicle. It is also possible for additional parameters for controlling the vehicle to be received via communication interface 12. Thus, for example, the rules for controlling the vehicle may be adapted dynamically. For instance, an overtaking ban may be activated or deactivated, thereby permitting or prohibiting use of another driving lane accordingly. Additionally, information about other objects that are outside the capture range of sensors 11-1 to 11-4 may be taken into account in this way. Such information may be transmitted to the host vehicle from vehicles that are ahead of the host vehicle or travelling in the opposite direction (car-to-car communication). Additional information may also be transmitted to the vehicle from other, stationary transmitters for example (car-to-X communication).

The information about objects in the area surrounding the vehicle acquired in this way, and possibly other boundary parameters as well, are transmitted to vector field generator 20. In this context, vector field generator 20 may be coupled with a further memory 21. This further memory 21 may hold control guidelines for controlling the vehicle, for example. Such control guidelines may be fixed rules for controlling a vehicle, for example. For example, they may include the instruction to drive on the right, that is to say the vehicle should preferably use the farthest right lane. Recommendations regarding minimum distances to be kept maintained from the side of a vehicle or behind a vehicle travelling in front may also be stored in memory 21. Of course, other guidelines are equally possible.

Vector field generator 20 analyses the information about objects in the area surrounding the vehicle that is received from the detector 10 and creates an environmental potential field from the information about the detected objects. This environmental potential field is a representation of the environment in the area surrounding the vehicle, in which a potential value is assigned to each of a multiplicity of single, discrete points in the area around the vehicle. The value of the points in the potential field increases as the danger the individual objects represent for the host vehicle increases. This means that, the higher the value of a potential in the environmental potential field, the more urgent it is to avoid steering the host vehicle toward such a point. Thus, the artificial potential field created in this way may be understood to be a risk map, on which the magnitude of the potential corresponds to a potential hazard for the host vehicle represented by a detected object.

For fast, homogeneous assignment of potential values for the detected objects, and possibly for other boundary conditions as well, fixed or dynamic models may be prescribed. For example, fixed potential distributions may be specified for individual objects or object classes. The potential fields may also be adapted dynamically depending on a speed of the host vehicle and/or a speed of the host vehicle relative to another object.

In order to create the environmental potential field, the objects detected in the area surrounding the vehicle may first be merged so that then a common environmental potential field is produced. Alternatively, it is also possible first to create individual potential fields for each object detected in the area surrounding the vehicle, or for groups of objects detected in the area surrounding the vehicle. These individual potential fields may then be superimposed on each other to yield a common, total potential field. This act of superimposing individual potential fields on each other makes it possible to combine objects detected by one or more sensors quickly and simply without first having to laboriously process and combine the individual sensor signals.

Vector field generator 20 is also able to read the control guidelines from memory 21 and to generate a suitable control potential field therefor. In this case too, it is possible to define the total potential field together with the information from the detected objects in the area surrounding the vehicle in a single step. Alternatively, it is equally possible to first calculate a separate control potential field from the control guidelines and then superimpose said control potential field and the total potential field of detected objects on one another.

After a potential field has been produced from all objects detected in the area surrounding the vehicle and optionally also from the additional control guidelines, vector field generator 20 calculates a vector field \vec{F}. This vector field \vec{F} is derived from the negative gradient of the previously calculated potential field ∪:

\vec{F}=_∇∪.

For a separate analysis of the control in the longitudinal and/or lateral direction, the negative gradient for each may also be calculated separately and only in the corresponding direction. If the driver assistance system is only to be used in the longitudinal direction for braking or accelerating, for example, it is also sufficient only to define the negative gradient in the vehicle's direction of travel. Conversely, a calculation of the negative gradient orthogonally to the direction of travel is sufficient for defining the steering parameters in the lateral direction.

In order to prevent oscillating lateral motion (slewing) particularly when making lateral manoeuvres, the lateral force (steering movement) may be attenuated. In this case, a possible attenuation factor must be selected large enough to ensure that the transient oscillation process into the travel lane is not perceived as disruptive by the driver. On the other hand, the attenuation factor must also not be so large that a possible lane change is delayed needlessly.

In the longitudinal direction, however, attenuation is not desirable, since nothing should prevent a braking action from responding as rapidly as possible.

For the purpose of the superposition principle, the laterally and longitudinally acting forces may be considered independently of each other.

Starting with the vector field generated in vector field generator 20, control commands are then calculated for the vehicle in control device 30. The definition of the control commands is based on the vector field that was calculated beforehand from the environmental potential field. The control commands calculated in this process yield a control for the vehicle in the direction of lowest hazard, as characterised by the previously calculated potentials. The control commands defined in control device 30 may then be forwarded directly to a vehicle electronic unit 31. Thus an at least semi-autonomous control operation is performed by the host vehicle. The vehicle electronic unit 31 evaluates the control commands defined by control device 30 and carries out a steering and/or a braking/accelerating operation completely or semi-autonomously. Other control operations, such as selectively activating a direction indicator, etc., are also possible.

In addition or alternatively to the preceding, however, it is also possible that the control commands defined by control device 30 are not incorporated directly for the purpose of autonomous control of the vehicle, but are only provided to the driver as information instead. For this purpose, for example, information may be provided early via a display device 32 or an optical signalling device 33 to enable the vehicle driver to respond actively. In this way, in the event of a dangerous situation the driver may be alerted to the danger in good time. Other haptic or signalling options besides the ones mentioned are also possible.

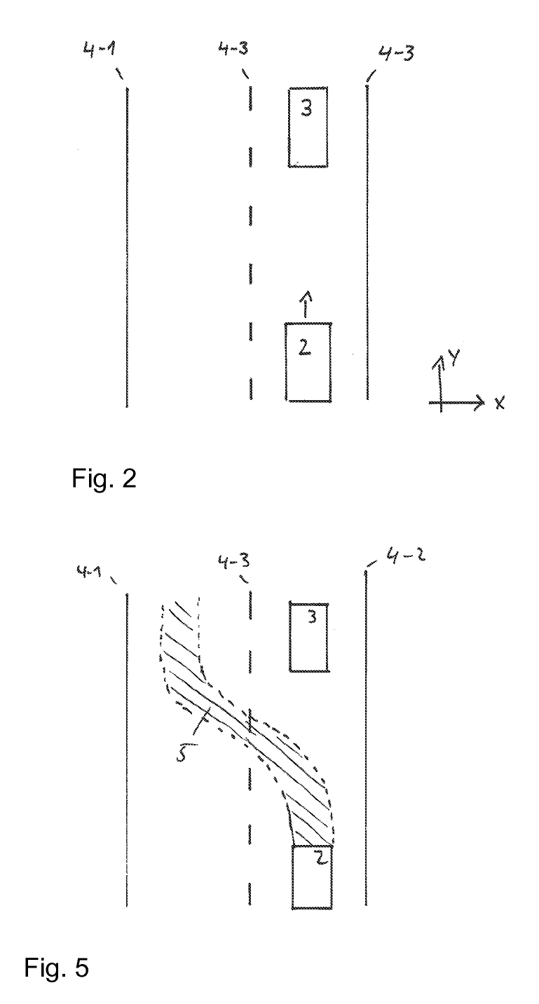

FIG. 2 is a schematic representation of a driving situation in which the host vehicle 2 is travelling behind another vehicle 3. In this context, for example, the car ahead may be detected and possibly the distance between the two vehicles may be determined for example by a first sensor. Other sensors may serve to capture the left lane marking 4-1 and the right lane marking 4-2, and thus also the direction of travel, as well as any upcoming bends in good time. A central lane marking 4-3 between the right and left lanes may also be captured by the same or even a different sensor. The travel direction of vehicle 2 progresses in the y-direction, and the x-direction extends orthogonally to the direction of travel.

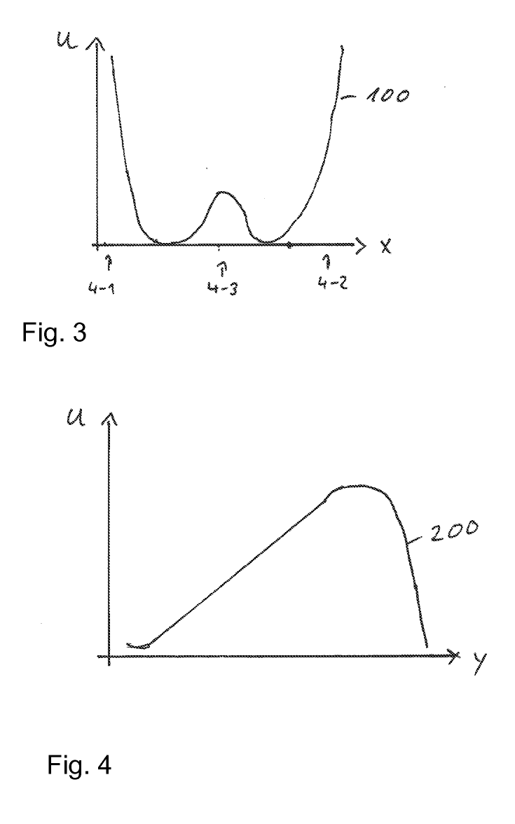

FIG. 3 is a schematic representation of a cross section through a potential curve 100 in the x-direction of FIG. 2, as derived for example for an environmental potential field from lane markings 4-1 to 4-3. In this case, a very sharp increase in potential is present on both left and right borders in the x-direction. This ensures that vehicle 2 is always positioned between lane markings 4-1 and 4-3. The dashed central lane marking 4-3 therebetween results in only a slight rise in potential. This ensures that vehicle 2 is consistently positioned in the middle of a lane. The slight rise in potential due to central lane marking 4-3 keeps the vehicle either in the left lane or in the right lane.

FIG. 4 is a schematic representation of a cross section through a potential curve 200 of a moving object, such as a vehicle 3 travelling ahead of the host vehicle. The longitudinal movement of both vehicles means that the area behind leading vehicle 3 is particularly critical. This area is delimited by statutory regulations regarding the safety distance. This must be taken into account when leading vehicles are modelled. For example, the vehicle potential of a leading vehicle 3 may be described with a Gaussian bell curve. This is extended toward the rear up to a defined distance with a linearly diminishing, tunnel-shaped potential depending on the absolute and relative speeds. In order to define the potential function of a vehicle travelling ahead of the host vehicle, the distance may thus be defined as follows:

d(v,vᵣₑₗ)=dₘᵢₙ+tₛ·v+tₐ·vᵣₑₗ

In this context, dₘᵢₙ describes the desired distance between the vehicles when stationary. The temporal separation tₛ represents a safety distance that should be maintained. tₐ describes a buffer in which the relative speed should be reduced if the host vehicle closes the gap between itself and the vehicle ahead. v describes the speed of the host vehicle, and vᵣₑₗ describes the relative speed between the host vehicle and the vehicle travelling ahead of it.

FIG. 5 shows a schematic representation of a driving path 5 in which host vehicle 2 performs an overtaking manoeuvre with regard to vehicle 3. Host vehicle 2 first draws closer to vehicle 3 ahead of it until a certain distance is reached. When a certain distance exists between leading vehicle 3 and host vehicle 2, the potential barrier with respect to leading vehicle 3 becomes higher than the potential barrier represented by the central lane marking 4-3. At this time, host vehicle 2 will begin to change from the right lane into the left lane, and subsequently continue its journey in the left lane. The potential hill in the middle lane marking 4-3 will be barely noticeable, but because of this barrier lane changing takes place in several phases. As soon as the potential hill caused by the vehicle 3 ahead is encountered, host vehicle 2 will carry out a slight steering adjustment to the left. This is followed by slight resistance due to the potential of the central lane marking 4-3. Once the resistance of the central lane marking 4-3 is overcome, another steering adjustment into the left lane is induced. Finally, the potential of the right border 4-1 of the lane causes countersteering in the left lane,

The scenario described here has been kept relatively simple to assist with understanding of the present disclosure. In other embodiments, the street model might be expanded to include twisting roads. A corresponding change in the model due to the occurrence of shear forces may also be considered.

With a vehicle having autonomous control capability based on the control commands from control device 3, overcontrol of the driving behavior by steering as well as with the brake and accelerator is preferably possible at all times. This ensures that the vehicle cannot become uncontrolled.

In the previously described example as well, only sensors in the direction of travel and to the side have been described, but it goes without saying, the system can also be extended to include sensors in another spatial direction. For example, an evaluation of the reverse travel area in particular is also possible and beneficial. In this way, it may be assured, for example, that account can be taken of vehicles approaching from the rear. In this case, it may be necessary to ensure that an overtaking manoeuvre is prevented.

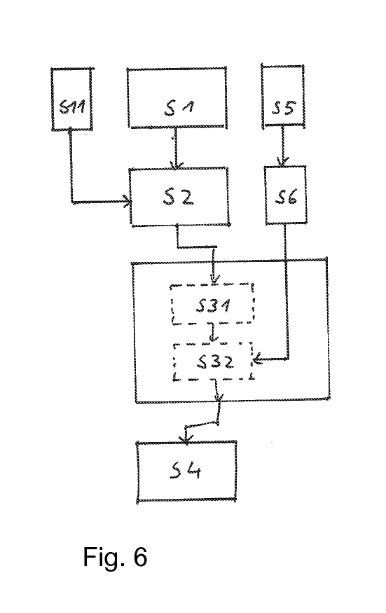

FIG. 6 shows a workflow chart for a method for operating a driver assistance system 1. In a step S1, at least one object is detected in the area surrounding object 2. In step S2, and environmental potential field is created for the at least one detected object, and in step S3 a vector field is calculated on the basis of the environmental potential field. Then, in step S4 a control command for the vehicle is defined on the basis of the calculated vector field.

If more than one object is detected, in a step S31 it is also possible superimpose a plurality of environmental potential fields on each other to obtain a total potential field. In this case, in step S3 the vector field may be calculated from the total potential field.

Additionally, information about at least one object in the area surrounding the vehicle may be received in an optional step S11. In step S11, additional rules and regulations, prohibitions and instructions may also be received.

In one embodiment, the method according to the disclosure also includes a further step S5 of providing control guidelines for controlling the vehicle, and a step S6 of creating a control potential field using the stored control guidelines. The control potential field and the environmental potential field are then superimposed on each other in step S32 to create a combined potential field.

In summary, the present disclosure relates to a driver assistance system for a vehicle, in which the information about the area surrounding the vehicle, and optionally other guidelines are synthesised in the form of a potential field. From this potential field, a vector field is generated, and this serves as the foundation for the longitudinal and/or lateral control of the vehicle. Efficient control of the vehicle is thus assured.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

16. A driver assistance system for a motor vehicle comprising:
a detector configured to detect at least one object in the area surrounding the vehicle;
a vector field generator configured to create an environmental potential field for the at least one object detected in the area surrounding the vehicle and to calculate a vector field from the created environmental potential field; and
a control device configured to define control commands for the vehicle on the basis of the calculated vector field, which commands will guide the vehicle past the at least one detected object.

17. The driver assistance system according to claim 16, wherein the vector field generator creates a plurality of environmental potential fields, superimposes the plurality of created environmental potential fields on each other to form a total potential field, and calculates the vector field from the total potential field.

18. The driver assistance system according to claim 16, wherein the detector comprises a plurality of sensors which detect an object in the area surrounding the vehicle.

19. The driver assistance system according claim 16, wherein the detector comprises at least one of a radar sensor, an ultrasonic sensor, a camera, and a LIDAR.

20. The driver assistance system according to claim 15, wherein the vector field generator is configured to adapt the environmental potential field for the object detected according to a speed of the vehicle and a relative speed between the vehicle and the detected object.

21. The driver assistance system according to claim 15, further comprising a memory configured to store control guidelines for controlling the vehicle, wherein the vector field generator generates a control potential field using the stored control guidelines and superimposes the control potential field on the environmental potential field.

22. The driver assistance system according to claim 15, wherein the detector comprises a communication interface configured to receive information about an object in the area surrounding the vehicle.

23. The driver assistance system according to claim 15, wherein the vector field generator creates the environmental potential field on the basis of a predetermined model.

24. A vehicle comprising:
a driver assistance system including:
a detector configured to detect at least one object in the area surrounding the vehicle;
a vector field generator configured to create an environmental potential field for the at least one object detected in the area surrounding the vehicle and to calculate a vector field from the created environmental potential field; and
a control device configured to define control commands for the vehicle on the basis of the calculated vector field, which commands will guide the vehicle past the at least one detected object.

25. A method for operating a driver assistance system for a vehicle comprising:
detecting at least one object in the area surrounding the vehicle;
creating an environmental potential field for the at least one detected object;
calculating a vector field from the created environmental potential field; and
defining a control command for the vehicle that guides the vehicle past the at least one detected object using the calculated vector field.

26. The method according to claim 25, further comprising superimposing a plurality of environmental potential fields on each other to produce a total potential field, wherein calculating the vector field comprises calculating the vector field from the total potential field.

27. The method according to either of claims 25, further comprising receiving information about at least one object in the area surrounding the vehicle.

28. The method according to claim 10, further comprising:
providing control guidelines for controlling the vehicle;
creating a control potential field using the stored control guidelines; and
superimposing the control potential field on the environmental potential field.

29. The method according to claim 10, wherein defining the control command comprises defining a control command for at least one of a longitudinal and a lateral control of the vehicle.
